(19) United States
(12) Patent Application Publication
(10) Pub. No.: US 2018/0032243 A1
(43) Pub. Date: Feb. 1, 2018

(54) METHODS AND DEVICES FOR MOVING ICONS BETWEEN DIFFERENT PAGES

(71) Applicant: Beijing Xiaomi Mobile Software Co., Ltd., Beijing (CN)

(72) Inventors: Xuhui LU, Beijing (CN); Bin WANG, Beijing (CN); Zhongliang QIAO, Beijing (CN)

(73) Assignee: Beijing Xiaomi Mobile Software Co., Ltd., Beijing (CN)

(21) Appl. No.: 15/634,075

(22) Filed: Jun. 27, 2017

(30) Foreign Application Priority Data
Jul. 27, 2016 (CN) 201610605204.7

(51) Int. Cl. G06F 3/0488; G06F 3/0484; G06F 3/0481

(52) U.S. Cl. CPC G06F 3/04883; G06F 3/04817; G06F 3/04845; G06F 2203/04803

(57) ABSTRACT

Methods and devices are provided for moving icons between different pages on a touch screen. The device determines whether an icon movement operation for a preset icon on a first desktop page is detected on the touch screen. The device acquires a movement direction of the icon movement operation when the icon movement operation is detected. The device displays a page switching identifier corresponding to the movement direction on the first page according to the movement direction. When the page switching identifier is activated by the icon movement operation, the device displays a second page.

### CROSS-REFERENCE TO RELATED APPLICATION

This application is based upon and claims priority to Chinese Patent Application No. 201610605204.7, filed on Jul. 27, 2016, the entire contents of which are incorporated herein by reference.

### TECHNICAL FIELD

The present disclosure generally relates to terminals technology, and more particularly, to a methods and devices for moving icons between different pages.

### BACKGROUND

To accommodate multiple application icons in one screen, a device may have a plurality of pages. In this disclosure, the page may also be referred as a desktop or a desktop page. When a user wants to move an application icon to rearrange the application icon, the user may need perform acts according to a specific process starting by touching and holding the application icon first. The specific process may include: when moving an application icon from a current page to other page, the user is required to press the icon to manually move the icon to an edge of the screen to further wait for page switching, and then continues moving the icon to a certain proper position on a different page. The existing method has the following problems: the user has to wait for a certain period of time after moving the icon to the edge of the screen, and then the page may be switched. In addition, when the user moves the icon to the edge of the screen, after the page is switched, the user is required to move away the icon immediately, otherwise the device may determine that the user tends to continue switching to the next page and thus continue switching the page to the next one, thereby moving the icon to a page unexpected by the user.

### SUMMARY

The embodiments of the present disclosure provide methods and devices for displaying multiple pages. The technical solutions are implemented as follows.

According to a first aspect of the present disclosure, a method may be implemented by a device including a touch screen controlled by at least one processor. The device determines whether an icon movement operation for a preset icon on a first desktop page is detected or not, where the first page may be a desktop page currently displayed on a touch screen. A movement direction of the icon movement operation is acquired when the icon movement operation is detected. A page switching identifier corresponding to the movement direction is displayed on the first page according to the movement direction. The device displays a second page corresponding to the movement direction when the page switching identifier is activated by the icon movement operation, where the second page may be a desktop page other than the first page.

According to a second aspect of the present disclosure, a device is provided that includes a touch screen, a processor that is electronically connected to the touch screen. The processor is configured to determine whether an icon movement operation for a preset icon on a first desktop page is detected or not, where the first desktop page may be a desktop page currently displayed on the touch screen. The processor is configured to acquire a movement direction of the icon movement operation when the icon movement operation is detected. The processor is configured to instruct the touch screen to display a page switching identifier corresponding to the movement direction on the first desktop page according to the movement direction. The processor is configured to instruct the touch screen to display a second desktop page when the page switching identifier is activated by the icon movement operation, where the second desktop page may be a desktop page, other than the first desktop page, corresponding to the movement direction.

According to a third aspect of the present disclosure, a desktop page display device is provided including: a processor; and a memory configured to store instructions executable by the processor. The processor is configured to: determine whether an icon movement operation for a preset icon on a first desktop page is detected or not, where the first desktop page may be a desktop page currently displayed on a touch screen; acquire a movement direction of the icon movement operation when the icon movement operation is detected; display a page switching identifier corresponding to the movement direction on the first desktop page according to the movement direction; and display a second desktop page when the page switching identifier is activated by the icon movement operation, where the second desktop page may be a desktop page, other than the first desktop page, corresponding to the movement direction.

It should be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure.

FIG. 1 is a flow chart showing a desktop page display method, according to an exemplary embodiment.

FIG. 2 is a flow chart showing other desktop pages display method, according to an exemplary embodiment.

FIG. 3 is a flow chart showing other desktop pages display method, according to an exemplary embodiment.

FIG. 4A is a schematic diagram illustrating a process and effect of moving icon A to first desktop switching identifier M, according to an exemplary embodiment.

FIG. 4B is a schematic diagram illustrating a process and effect of moving icon A to a second desktop switching identifier N, according to an exemplary embodiment.

FIG. 5 is a flow chart showing other desktop pages display method, according to an exemplary embodiment.

FIG. 6 is a flow chart showing other desktop pages display method, according to an exemplary embodiment.

FIG. 7 is a flow chart showing other desktop pages display method, according to an exemplary embodiment.

FIG. 8 is a block diagram of a desktop page display device, according to an exemplary embodiment.

FIG. 9 is a block diagram of other desktop pages display device, according to an exemplary embodiment.

FIG. 10 is a block diagram of other desktop pages display device, according to an exemplary embodiment.

FIG. 11 is a block diagram of other desktop pages display device, according to an exemplary embodiment.

FIG. 12 is a block diagram of other desktop pages display device, according to an exemplary embodiment.

FIG. 13 is a block diagram of other desktop pages display device, according to an exemplary embodiment.

FIG. 14 is a block diagram of other desktop pages display device, according to an exemplary embodiment.

FIG. 15 is a block diagram of an apparatus applying a desktop page display device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with some aspects related to the present disclosure as recited in the appended claims.

When multiple applications are arranged in desktop software, a user is usually required to move a certain application icon to rearrange the application icon, thereby achieving better visual and experience effects. A specific movement process is as follows: when being required to move a certain icon from a current desktop page to other desktop page, the user is required to press the icon to manually move the icon to an edge of a screen to further wait for desktop switching, and then continues moving the icon to a certain proper position on a switched desktop. Such an icon cross-desktop movement manner has the following problems: the user has to wait for a certain period of time after moving the icon to the edge of the screen, and then the desktop page may be switched. In addition, when the user moves the icon to the edge of the screen, after the desktop page is switched, the user is required to move away the icon immediately, otherwise the desktop software may determine that the user tends to continue switching the desktop page and thus continue switching the desktop page, thereby moving the icon to a desktop page unexpected by the user.

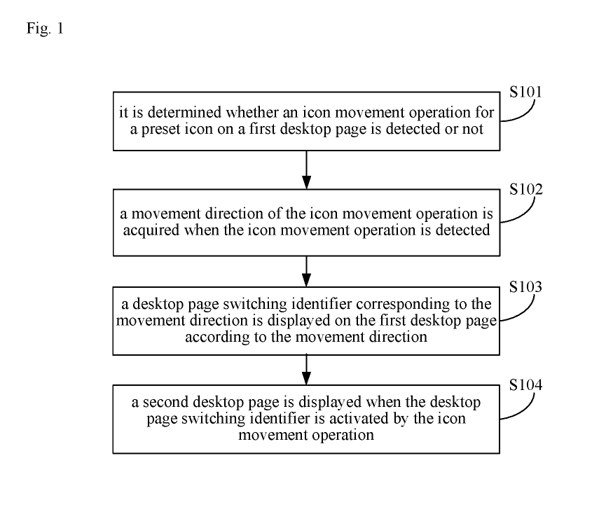

In order to solve the above technical problems, the embodiments of the present disclosure provides a desktop page display method, which may be applied to an icon movement program, system and device. An execution main body corresponding to the method may be a terminal installed with a touch screen, such as a mobile phone, a PAD and a computer. The terminal may adopt any operating system, which may include an Android operating system, a Windows operating system, and an OS X operating system. As shown in FIG. 1, the method includes the following Step 101 to Step 104.

At Step 101, it is determined whether an icon movement operation for a preset icon on a first desktop page is detected or not, where the first desktop page is a desktop page currently displayed on a touch screen.

The preset icon may be any application icon or an icon of any folder on the desktop page currently displayed on the touch screen. The icon movement operation may be a long pressing and moving operation and the like.

At Step 102, a movement direction of the icon movement operation is acquired when the icon movement operation is detected.

At Step 103, a page switching identifier corresponding to the movement direction is displayed on the first desktop page according to the movement direction.

Herein, the page switching identifier is substantially an icon of an application, and may be activated to trigger an event of switching the desktop page currently displayed on the touch screen into a desktop page to which the user expects to switch the preset icon. In such a manner, when the icon movement operation is detected to activate the page switching identifier, the event of switching the desktop page is triggered to notify desktop page switching software (such as a desktop page application) installed on the terminal to switch the desktop page currently displayed on the touch screen to the second desktop page.

In addition, the page switching identifier may be an icon in any shape such as a rectangle, a round and a triangle, and its background color may be personalized as long as transparency is unequal to 100% when the page switching identifier is displayed. Of course, in order to not make the user confuse about the page switching identifier and another icon on the desktop page, the background color of the page switching identifier may be colorless, dark color or the like.

At Step 104, a second desktop page is displayed when the page switching identifier is activated by the icon movement operation, where the second desktop page is different from the first desktop page and corresponds to the movement direction. Thus, the device may display the second page corresponding to the movement direction when the corresponding page switching identifier is activated by the icon movement operation. The second page may accommodate and display the icon after the step 104 is accomplished.

When the page switching identifier is activated by the icon movement operation, the event of switching the desktop page currently displayed on the touch screen into the second desktop page to which the user expects to move the preset icon may be triggered, so that the preset icon is moved from the first desktop page to the second desktop page. In such a manner for implementing cross-desktop page movement of an icon via the page switching identifier, the icon may be moved more flexibly, conveniently and accurately. It is unnecessary for the user to further wait for a certain period of time to implement the cross-desktop movement of the icon when moving the icon to the edge of the screen. In addition, the problem of mistaken continuous desktop page switching caused by the fact that a finger of the user does not move away the icon immediately in an icon cross-desktop movement manner in a related technology is solved.

In addition, movement of the preset icon to the second desktop page is implemented after the second desktop page becomes the desktop page currently displayed on the touch screen, and a position of the preset icon on the second desktop page may be the same as a position of the page switching identifier on the first desktop page. Of course, the user may also continue moving the preset icon to another position on the second desktop page according to a personal requirement.

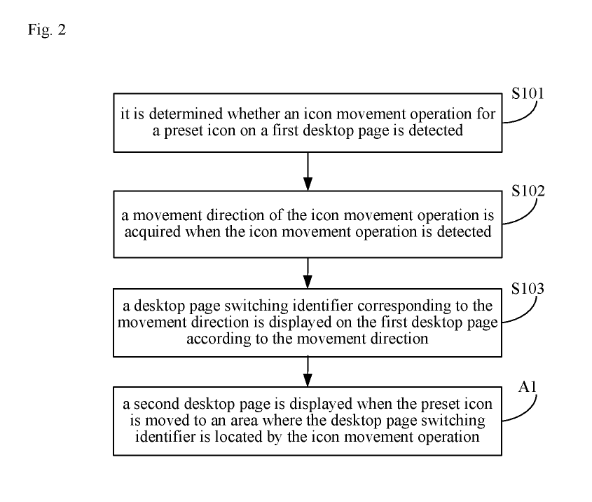

As shown in FIG. 2, in an embodiment, Step 104 in FIG. 1 may be executed as follows.

At Step A1, the second desktop page is displayed when the preset icon is moved to an area where the page switching identifier is located by the icon movement operation, where the area where the page switching identifier is located is a display area occupied by the page switching identifier on the touch screen, and when the preset icon is moved to the area where the page switching identifier is located, a display area of the preset icon may be smaller than/equal to/larger than the area where the page switching identifier is located. Here, the area may further be displayed with a dashed circle, a dashed square, or a pre-defined shape according to customer setup that surrounds the page switching identifier. The size of the area may also be adjusted by the device in the setup if desired.

The operation that the page switching identifier is activated by the icon movement operation may be the operation that the preset icon is moved to the area where the page switching identifier is located by the icon movement operation. As such, the page switching identifier is activated when the preset icon is monitored to be moved to the area where the page switching identifier is located by the icon movement operation, and after the page switching identifier is activated, the event of switching the desktop page currently displayed on the touch screen to the second desktop page to which the user expects to move the preset icon is triggered to notify the desktop page switching software (such as the desktop page application) installed on the terminal to switch the desktop page currently displayed on the touch screen to the second desktop page, thereby flexibly and accurately implementing cross-desktop movement of the preset icon through the page switching identifier.

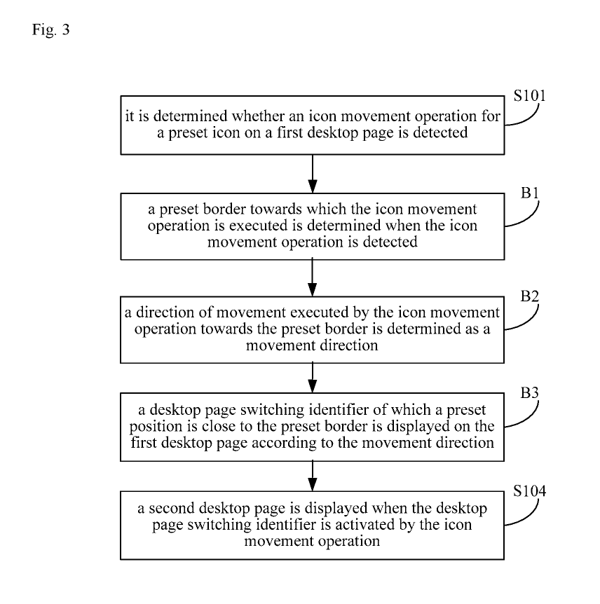

As shown in FIG. 3, in an embodiment, Step 102 shown in FIG. 1 may be executed as follows.

At Step B1, a preset border towards which the icon movement operation is executed is determined when the icon movement operation is detected.

At Step B2, a direction of movement executed by the icon movement operation towards the preset border is determined as the movement direction, where the preset border includes: a first preset border or a second preset border.

The user may freely place the terminal, that is, a placement posture of the terminal may be diversified. The user always moves an icon towards a certain border regardless of the placement posture of the terminal For conveniently and accurately acquiring the movement direction of the icon movement operation, the direction of movement executed by the icon movement operation towards the preset border is determined as the movement direction. The first preset border and the second preset border may be two vertical borders or two transverse borders of the terminal. Both the transverse borders and the vertical borders are borders perpendicular to a direction in which the desktop page may be switched. For example, for a mobile phone, the direction in which the desktop page may be switched may be a direction perpendicular to the two vertical borders, so that the first preset border and the second preset border may be the two vertical borders. For a PAD, the direction in which the desktop page may be switched is a direction perpendicular to the two vertical borders/a direction perpendicular to the two transverse borders, so that the first preset border and the second preset border may be the two vertical borders or the two transverse borders.

In addition, the direction of movement towards the preset border includes: a direction of perpendicular movement towards the preset border and a direction of oblique movement towards the preset border.

Step 103 shown in FIG. 1 may be executed as follows.

At Step B3, the page switching identifier with a preset position that is close to the preset border is displayed on the first desktop page according to the movement direction, where the preset position of the page switching identifier may be preset, and may preferably be a position which is at the edge of the preset border and where there is no icon. The device may display the page switching identifier with a preset position that is close to the preset border according to the movement direction.

The page switching identifier corresponding to the movement direction may be a page switching identifier pre-bound with the movement direction, and since the movement direction is a direction to the preset border, the page switching identifier pre-bound with the movement direction is a page switching identifier with a relationship with the preset border. When the movement direction is to a certain border, the page switching identifier which corresponds to the border and the identifier's preset position is close to the preset border may be displayed. For example, the device may display the page switching identifier with its preset position that is close to the preset border and corresponds to the preset border on the first desktop page. Therefore, the user may conveniently, rapidly and accurately implement the cross-desktop movement of the preset icon according to the page switching identifier which is bound with the movement direction and close to the preset border.

For example, when the movement direction is a first direction to the first preset border, a first page switching identifier bound with the first direction is displayed at a preset position close to the first preset border on the first desktop page. When the movement direction is a second direction to the second preset border, a second page switching identifier bound with the second direction is displayed at a preset position close to the second preset border on the first desktop page.

In addition, the preset border includes two borders, i.e. the first preset border and the second preset border. Under such a condition, there are two page switching identifiers in the terminal, and preset positions of the two page switching identifiers are close to the corresponding preset borders (that is, the preset positions are positions at distances not larger than a preset distance threshold value away from the corresponding preset borders).

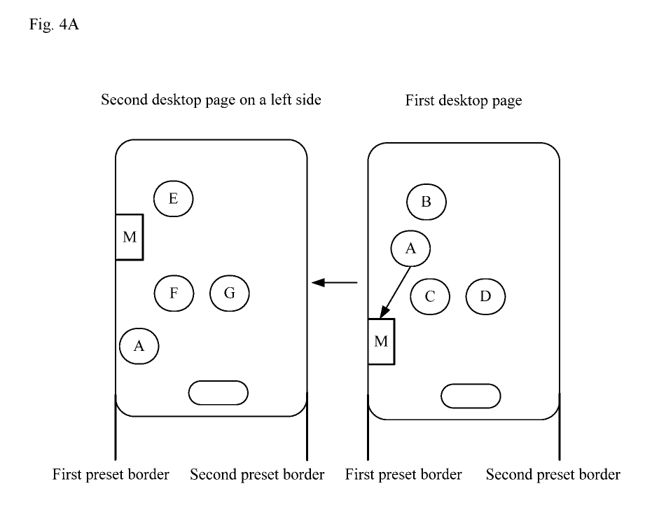

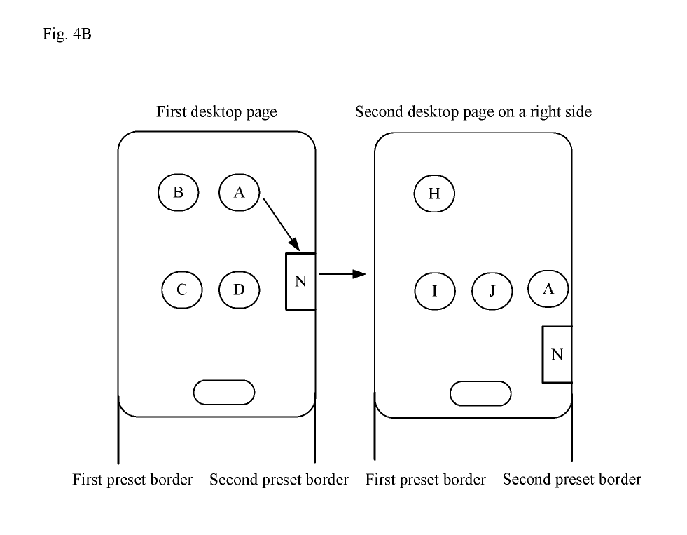

Finally, only one page switching identifier is displayed on the touch screen at the same time, so that excessive occupation of a desktop page space is avoided on the basis of meeting an icon cross-desktop movement requirement of the user. For example, the first preset border may include a left-side vertical border and the second preset border may include a right-side vertical border. When the movement direction is the first direction (to the left), the first page switching identifier with the preset position is close to the left-side vertical border is displayed (as shown in FIG. 4A, where each letter in FIG. 4A represents an icon, different letters represent different icons, icon M in the first desktop page is the first page switching identifier, icon A in FIG. 4A is the preset icon, and an arrow of icon A represents the movement direction of icon A). When the movement direction is the second direction (to the right), the second page switching identifier with the second preset position is close to the right-side vertical border is displayed (as shown in FIG. 4B, where each letter in FIG. 4B represents an icon, different letters represent different icons, icon N in the first desktop page in FIG. 4B is the second page switching identifier, icon A in FIG. 4B is the preset icon, and the arrow of icon A represents the movement direction of icon A).

In an embodiment, Step 103 shown in FIG. 1 may be executed as follows.

The page switching identifier is displayed at a position close to a right side of the screen on the first desktop page when the movement direction is from left to right, where the position close to the right side of the screen is a position close to the right side after the screen is equally divided into left and right parts; or

the page switching identifier is displayed at a position close to a left side of the screen on the first desktop page when the movement direction is from right to left, where the position close to the left side of the screen is a position close to the left side after the screen is equally divided into the left and right parts; or

the page switching identifier is displayed at a position close to a lower side of the screen on the first desktop page when the movement direction is from top to bottom, where the position close to the lower side of the screen is a position close to the lower side after the screen is equally divided into upper and lower parts, and when the page switching identifier is displayed at the position close to the lower side of the screen on the first desktop page, the placement posture of the terminal may be a vertical screen state or a non-vertical screen state (such as a transverse screen state); or

the page switching identifier is displayed at a position close to an upper side of the screen on the first desktop page when the movement direction is from bottom to top, where the position close to the lower side of the screen is a position close to the upper side after the screen is equally divided into the upper and lower parts, and when the page switching identifier is displayed at the position close to the upper side of the screen on the first desktop page, the placement posture of the terminal may be the vertical screen state or the non-vertical screen state (such as the transverse screen state).

The page switching identifier corresponding to the movement direction may also be a page switching identifier which does not form a binding relationship with the movement direction but of which a display position is consistent with the movement direction. For such a page switching identifier, a specific display manner is as mentioned above. By the desktop page display manner, only one page switching identifier is displayed on the touch screen at the same time, so that excessive occupation of the desktop page space is avoided on the basis of meeting the icon cross-desktop movement requirement of the user. Moreover, the display position of the page switching identifier is consistent with the movement direction, so that great convenience is brought to the cross-desktop page movement of the preset icon by the user.

In addition, the page switching identifier does not form the binding relationship with the movement direction, so that the page switching identifiers displayed at the positions close to the right side/left side/upper side/lower side of the screen on the first desktop page may be the same page switching identifier, and may also be multiple different page switching identifiers.

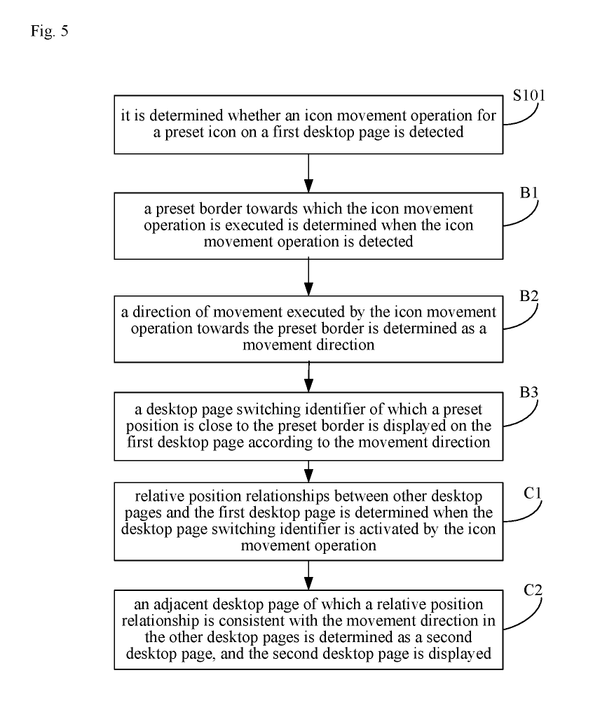

As shown in FIG. 5, in an embodiment, Step 104 in FIG. 1 may be executed as follows.

At Step C1, a relative position relationship between other desktop pages and the first desktop page is determined when the page switching identifier is activated by the icon movement operation, where the other desktop pages includes: a desktop page, other than the first desktop page, in at least two desktop pages stored in equipment where the touch screen is located.

At Step C2, an adjacent desktop page of which a relative position relationship is consistent with the movement direction in other desktop pages is determined as the second desktop page, and the second desktop page is displayed.

The adjacent desktop page is a first desktop page proximate to the first desktop page on the right side if the movement direction is rightward (including obliquely rightward and perpendicularly rightward), the adjacent desktop page is a first desktop page proximate to the first desktop page on the left side if the movement direction is leftward (including obliquely leftward and perpendicularly leftward), the adjacent desktop page is a first desktop page which is proximate to the first desktop page and may appear by an upward swipe if the movement direction is upward (including obliquely upward and perpendicularly upward, under such a condition, if the terminal is a mobile phone, its placement state may be the transverse screen state), and the adjacent desktop is a first desktop page which is proximate to the first desktop page and may appear by a downward swipe if the movement direction is downward (including obliquely downward and perpendicularly downward, under such a condition, if the terminal is a mobile phone, its placement state may be the transverse screen state).

The adjacent desktop page of which the relative position relationship is consistent with the movement direction in the other desktop page is determined as the second desktop page, so that the icon may be moved to the second desktop page consistent with the movement direction and proximate to the first desktop page.

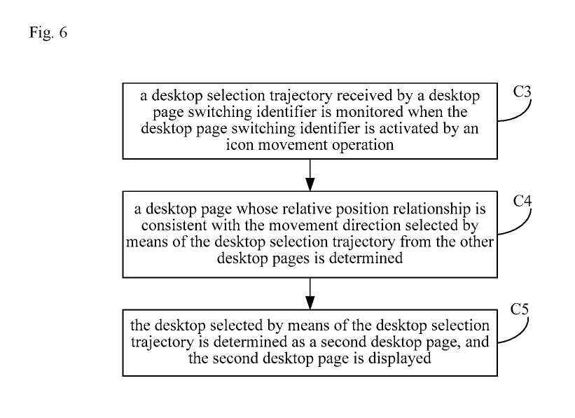

As shown in FIG. 6, in an embodiment, Step 104 in FIG. 1 may be executed as follows.

At Step C3, a desktop selection trajectory received by the page switching identifier is monitored when the page switching identifier is activated by the icon movement operation.

At Step C4, a desktop page whose relative position relationship is consistent with the movement direction selected by means of the desktop selection trajectory from the other desktop page is determined.

Herein the desktop selection trajectory may be a numeral trajectory, and numerals may be Arabic numerals, so that the terminal may determine the desktop page to the user expects to move the preset icon. For example, if expecting to move the preset icon to an Nth desktop page consistent with the movement direction, the user may input numeral N into the page switching identifier, and then the terminal may determine that the user expecting to move the preset icon to the Nth desktop page in desktop pages consistent with the movement direction when monitoring that the page switching identifier receives a desktop selection trajectory of numeral N.

At Step C5, the desktop page selected by means of the desktop selection trajectory is determined as the second desktop page, and the second desktop page is displayed.

When moving the preset icon, the user may not expect to move the preset icon to the adjacent desktop page, and may also be expected to continuously move the preset icon by N (N is a positive integer more than 2) desktop pages, so that the desktop selection trajectory received by the page switching identifier may also be monitored and the desktop selection trajectory may further be analyzed to determine the desktop page to which the user expects to move the preset icon in the desktop pages consistent with the movement direction.

Therefore, the desktop page corresponding to the desktop selection trajectory is selected from the desktop pages consistent with the movement direction as the second desktop page, and the second display page is further displayed to implement movement of the preset icon from the first desktop page to the second desktop page. For example, if the movement direction is a direction to the left-side vertical border/from right to left, when the preset icon is moved to a left-side page switching identifier, it may be determined that all desktop pages on the left side of the first desktop page are desktop pages consistent with the movement direction at first, and if the left-side page switching identifier is monitored to receive a trajectory of numeral “3”, a third desktop page on the left side of the first desktop page is determined as the second desktop page, and the second desktop page is further displayed, so that the preset icon is moved to the third desktop page on the left side of the first desktop page by the left-side page switching identifier.

For another example, if the movement direction is a direction to the right-side vertical border/from left to right, when the preset icon is moved to a right-side page switching identifier, it may be determined that all desktop pages on the right side of the first desktop page are desktop pages consistent with the movement direction at first, and if the right-side page switching identifier is monitored to receive a trajectory of numeral “2”, a second desktop page on the right side of the first desktop page is determined as the second desktop page, and the second desktop page is further displayed, so that the preset icon is moved to the second desktop page on the right side of the first desktop page by the right-side page switching identifier.

In an embodiment, Step 103 may be executed as follows.

The page switching identifier is displayed when a distance between the preset icon and a preset reference object is smaller than a preset distance and the desktop page of which the relative position relationship is consistent with the movement direction in the other desktop page is not null, where the preset reference object includes: the preset border or the desktop switching identifier, and the preset distance may be freely set, and for example, may be a half of a distance between the vertical borders on the two sides or a half of a distance between the two transverse borders or ⅔ of the distance.

Since the preset border is usually a vertical border or a transverse border, if the distance between the preset icon and the preset border to which the movement direction is/the page switching identifier is smaller than the preset distance, it is indicated that the preset icon is not positioned at a middle position of the screen and is close to the preset border/page switching identifier. On such a basis, if the desktop page of which the relative position relationship is consistent with the movement direction in the other desktop page is not null (that is, from the first desktop page, there is at least one other desktop pages in the movement direction), it is indicated that the preset icon may move towards the desktop page consistent with the movement direction. Therefore, the page switching identifier may be displayed to facilitate free movement of the preset icon from the first desktop page to the second desktop page through the page switching identifier.

In an embodiment, the method further includes that:

the page switching identifier is hidden when a preset icon hiding condition is met, where the preset icon hiding condition includes at least one of the following conditions that:

the icon movement operation is not detected,

where it is indicated that the user does not move the icon when the icon movement operation is not detected, so that the page switching identifier may be hidden, the page switching identifier is not required to be displayed, and influence on the user is avoided; or

the distance between the preset icon and the preset reference object which the movement direction is to is larger than or equal to the preset distance,

where it is indicated that the preset icon is yet far away from the preset reference object (for example, the preset icon is positioned at a middle position of the screen) and the user even may only expect to move the preset icon in the first desktop page if the distance between the preset icon and the preset reference object which the movement direction is to is larger than or equal to the preset distance, so that it is unnecessary to immediately display the page switching identifier at this moment, and the page switching identifier may be temporally hidden, that is, the page switching identifier is not displayed on the first desktop page to avoid influence of early display of the page switching identifier on the user; or

the desktop page of which the relative position relationship is consistent with the movement direction in the other desktop pages is null,

where it is indicated that there is no desktop page consistent with the movement direction in the at least two desktop pages and it is impossible to move the preset icon to the second desktop page without creating a new desktop page consistent with the movement direction if the desktop page of which the relative position relationship is consistent with the movement direction in the other desktop page is null, so that the page switching identifier may be hidden, that is, the page switching identifier is not displayed on the first desktop page.

For example, if the monitored movement direction is the direction to the left-side vertical border/from right to left, the desktop pages on the left side of the first desktop page are all theoretically desktop pages of which the relative position relationships are consistent with the movement direction in the other desktop pages, but if the desktop page of which the relative position relationship is consistent with the movement direction in the other desktop page is null, it is indicated that there is no desktop page on the left side of the first desktop page in the at least two existing desktop pages, and it is impossible to continue moving the preset icon to a left-side desktop page under the condition of not creating a new left-side desktop page, so that it is unnecessary to display the page switching identifier, and the page switching identifier may be hidden, that is, the page switching identifier on the left side is not displayed on the first desktop page.

For another example, if the movement direction is the direction to the right-side vertical border/from left to right, the desktop pages on the right side of the first desktop page are all theoretically desktop pages of which the relative position relationships are consistent with the movement direction in the other desktop pages, but if the desktop page of which the relative position relationship is consistent with the movement direction in the other desktop page is null, it is indicated that there is no desktop page on the right side of the first desktop page in the at least two existing desktop pages, and it is impossible to continue moving the preset icon to a right-side desktop page under the condition of not creating a new right-side desktop page, so that it is unnecessary to display the page switching identifier on the right side, and the page switching identifier on the right side may be hidden, that is, the page switching identifier on the right side is not displayed on the first desktop page.

In an embodiment, the method further includes that:

a display position of the page switching identifier on the first desktop page is different from a display position of the page switching identifier on the second desktop page.

Since the second desktop page may be any desktop page other than the first desktop page in the at least two desktop pages, the display position of the page switching identifier on the first desktop page is different from the display position of the page switching identifier on the second desktop page to avoid the page switching identifier being overlapped when being displayed on different desktop pages and eliminate worries from the user about mistaken continuous desktop page switching caused by the fact that the icon is not rapidly moved away from the original position, corresponding to the page switching identifier, on the first desktop page after being moved to the second desktop page.

For example, when the first preset border is the left-side vertical border and the movement direction is the direction to the left-side vertical border/the movement direction is from right to left, the preset icon may be moved from the first desktop page to other desktop pages proximate to the first desktop page (such as a left-side desktop page proximate to the first desktop page) when the preset icon is moved to the area where the first page switching identifier is located on the first desktop page, but because positions of the first page switching identifier on the first desktop page and the other desktop page on the left side of the first desktop page are different (for example, as shown in FIG. 4A, positions of a first page switching identifier M on the first desktop page and the second desktop page are different, and of course, in FIG. 4A, when icon A is moved to the second desktop page on the left side, if the abovementioned preset icon hiding condition is met, the first page switching identifier M is not displayed, and here, the first page switching identifier M is displayed on the second desktop page just for describing that the positions of the first page switching identifier M on different desktop pages are different), even though the preset icon is not continuously moved to another position on the second desktop page, the condition that the preset icon is mistakenly continuously moved to the desktop page on the left side may be avoided because the preset icon is not located in the area where the first page switching identifier is located on the second desktop page.

For another example, when the second preset border is the right-side vertical border and the movement direction is the direction to the right-side vertical border/the movement direction is from left to right, the preset icon may be moved from the first desktop page to other desktop pages on the right side of the first desktop page (such as a right-side desktop page proximate to the first desktop page) when the preset icon is moved to the area where the second page switching identifier is located on the first desktop page, but because positions of the second page switching identifier on the first desktop page and the other desktop page on the right side of the first desktop page are different (for example, as shown in FIG. 4B, positions of a second page switching identifier N on the first desktop page and the second desktop page are different, and of course, in FIG. 4B, when icon A is moved to the second desktop page on the right side, if the abovementioned preset icon hiding condition is met, the second page switching identifier N is not displayed, and here, the second page switching identifier N is displayed on the second desktop page just for describing that the positions of the second page switching identifier N on different desktop pages are different), even though the preset icon is not continuously moved to another position on the second desktop page, the condition that the preset icon is mistakenly continuously moved to the desktop page on the right side may be avoided because the preset icon is not located in the area where the second page switching identifier is located on the second desktop page.

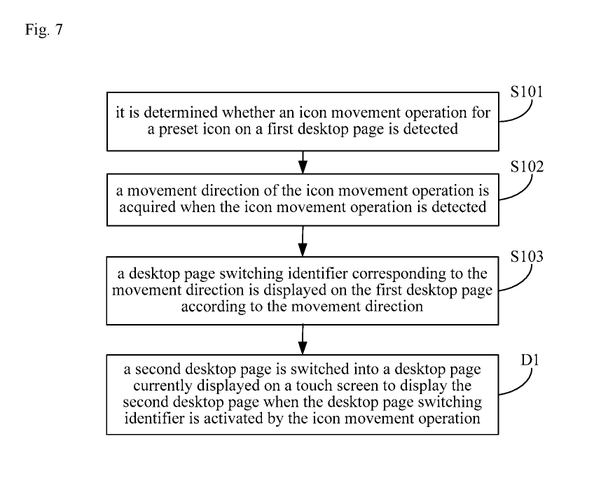

As shown in FIG. 7, in an embodiment, Step 104 may be executed as follows.

At Step D1, the second desktop page is switched into a desktop page currently displayed on the touch screen to display the second desktop page when the page switching identifier is activated by the icon movement operation.

When the page switching identifier is activated by the icon movement operation, the desktop page software may be notified to switch the second desktop page into the desktop page currently displayed on the touch screen to automatically move the preset icon from the first desktop page to the second desktop page.

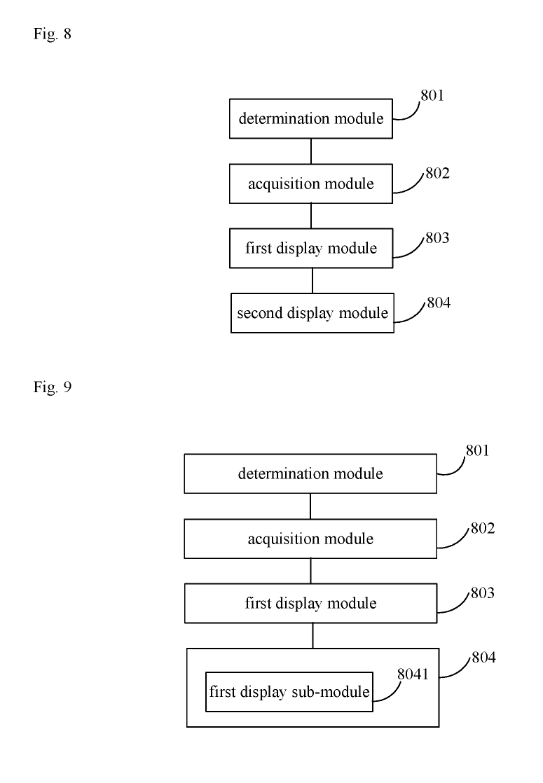

Corresponding to the desktop page display method provided by the embodiments of the present disclosure, the embodiments of the present disclosure further provide a desktop page display device, and as shown in FIG. 8, the device may include at least: a determination module 801, an acquisition module 802, and a first display module 803.

The determination module 801 is configured to determine whether an icon movement operation for a preset icon on a first desktop page is detected or not, where the first desktop page is a desktop page currently displayed on a touch screen. The acquisition module 802 is configured to acquire a movement direction of the icon movement operation when the icon movement operation is detected. The first display module 803 is configured to display a page switching identifier corresponding to the movement direction on the first desktop page according to the movement direction.

Here, the page switching identifier is substantially an icon of an application, and may be activated to trigger an event of switching the desktop page currently displayed on the touch screen into a desktop page (such as a second desktop page) to which the user expects to switch the preset icon, and in such a manner, when the icon movement operation is detected to activate the page switching identifier, the event of switching the desktop page is triggered to notify desktop page switching software (such as a desktop page application) installed on a terminal to switch the desktop page currently displayed on the touch screen to the second desktop page.

The device may further include a second display module 804, which is configured to display a second desktop page when the page switching identifier is activated by the icon movement operation, where the second desktop page is a desktop page, other than the first desktop page, corresponding to the movement direction.

When the page switching identifier is activated by the icon movement operation, the event of switching the desktop page currently displayed on the touch screen into the second desktop page to which the user expects to move the preset icon may be triggered, so that the second desktop page becomes the desktop page currently displayed on the touch screen, the preset icon is moved from the first desktop page to the second desktop page. In such a manner for implementing cross-desktop page movement of an icon via the page switching identifier, the icon may be moved more flexibly, conveniently and accurately. It is unnecessary for the user to further wait for a certain period of time to implement the cross-desktop movement of the icon when moving the icon to the edge of the screen. In addition, the problem of mistaken continuous desktop page switching caused by the fact that a finger of the user does not move away the icon immediately in an icon cross-desktop movement manner in the related technology is solved.

In addition, movement of the preset icon to the second desktop page is implemented after the second desktop page becomes the desktop page currently displayed on the touch screen, a position of the preset icon on the second desktop page may be the same as a position of the page switching identifier on the first desktop page, and of course, the user may also continue moving the preset icon to another position on the second desktop page according to a personal requirement.

As shown in FIG. 9, in an embodiment, the second display module 804 may include: a first display sub-module 8041, which is configured to display the second desktop page when the preset icon is moved to an area where the page switching identifier is located by the icon movement operation.

The operation that the page switching identifier is activated by the icon movement operation may be the operation that the preset icon is moved to the area where the page switching identifier is located by the icon movement operation, then, the page switching identifier is activated when the preset icon is monitored to be moved to the area where the page switching identifier is located by the icon movement operation, and after the page switching identifier is activated, the event of switching the desktop page currently displayed on the touch screen to the second desktop page to which the user expects to move the preset icon to is triggered to notify the desktop page switching software (such as the desktop page application) installed on the terminal to switch the desktop page currently displayed on the touch screen to the second desktop page, thereby flexibly and accurately implementing cross-desktop movement of the preset icon through the page switching identifier.

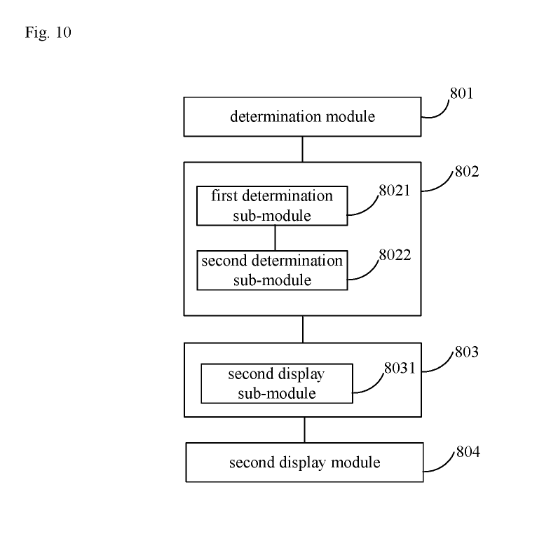

As shown in FIG. 10, in an embodiment, the acquisition module 802 may include: a first determination sub-module 8021 and a second determination sub-module 8022. The first determination sub-module 8021 is configured to determine a preset border towards which the icon movement operation is executed when the icon movement operation is detected. The second determination sub-module 8022 is configured to determine a direction of movement executed by the icon movement operation towards the preset border as the movement direction, where the preset border includes: a first preset border or a second preset border.

The first display module 803 includes: a second display sub-module 8031, configured to display the page switching identifier of which a preset position is close to the preset border on the first desktop page.

The page switching identifier corresponding to the movement direction may be a page switching identifier pre-bound with the movement direction, and since the movement direction is a direction to the preset border, the page switching identifier pre-bound with the movement direction is a page switching identifier with a corresponding relationship with the preset border, and when the movement direction is to a certain border, the page switching identifier which corresponds to the border and of which the preset position is close to the preset border may be displayed by displaying the page switching identifier of which the preset position is close to the preset border and which corresponds to the preset border on the first desktop page; and therefore, the user may conveniently, rapidly and accurately implement the cross-desktop movement of the preset icon according to the page switching identifier which is bound with the movement direction and close to the preset border.

In an embodiment, the first display module 803 may further include at least one of the following:

a third display sub-module, configured to display the page switching identifier at a position close to a right side of the screen on the first desktop page when the movement direction is from left to right;

a fourth display sub-module, configured to display the page switching identifier at a position close to a left side of the screen on the first desktop page when the movement direction is from right to left;

a fifth display sub-module, configured to display the page switching identifier at a position close to a lower side of the screen on the first desktop page when the movement direction is from top to bottom; or

a sixth display sub-module, configured to display the page switching identifier at a position close to an upper side of the screen on the first desktop page when the movement direction is from bottom to top.

The page switching identifier corresponding to the movement direction may also be a page switching identifier which does not form a binding relationship with the movement direction but of which a display position is consistent with the movement direction. For such a page switching identifier, a specific display manner is as mentioned above. By the desktop page display manner, only one page switching identifier is displayed on the touch screen at the same time, so that excessive occupation of the desktop page space is avoided on the basis of meeting the icon cross-desktop movement requirement of the user. Moreover, the display position of the page switching identifier is consistent with the movement direction, so that great convenience is brought to the cross-desktop page movement of the preset icon by the user.

In addition, the page switching identifier does not form the binding relationship with the movement direction, so that the page switching identifiers displayed at the positions close to the right side/left side/upper side/lower side of the screen on the first desktop page may be the same page switching identifier, and may also be multiple different page switching identifiers.

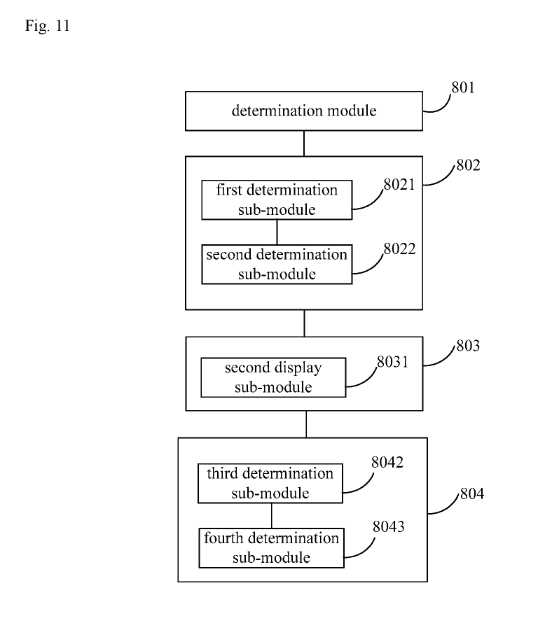

As shown in FIG. 11, in an embodiment, the second display module 804 includes: a third determination sub-module 8042 and a fourth determination sub-module 8043.

The third determination sub-module 8042 is configured to determine a relative position relationship between other desktop pages and the first desktop page when the page switching identifier is activated by the icon movement operation, where the other desktop pages includes: a desktop page, other than the first desktop page, in at least two desktop pages stored in equipment where the touch screen is located.

The fourth determination sub-module 8043 is configured to determine an adjacent desktop page of which a relative position relationship is consistent with the movement direction in the other desktop pages as the second desktop page, and display the second desktop page.

The adjacent desktop page of which the relative position relationship is consistent with the movement direction in the other desktop pages is determined as the second desktop page, so that the icon may be moved to the second desktop page consistent with the movement direction and proximate to the first desktop page.

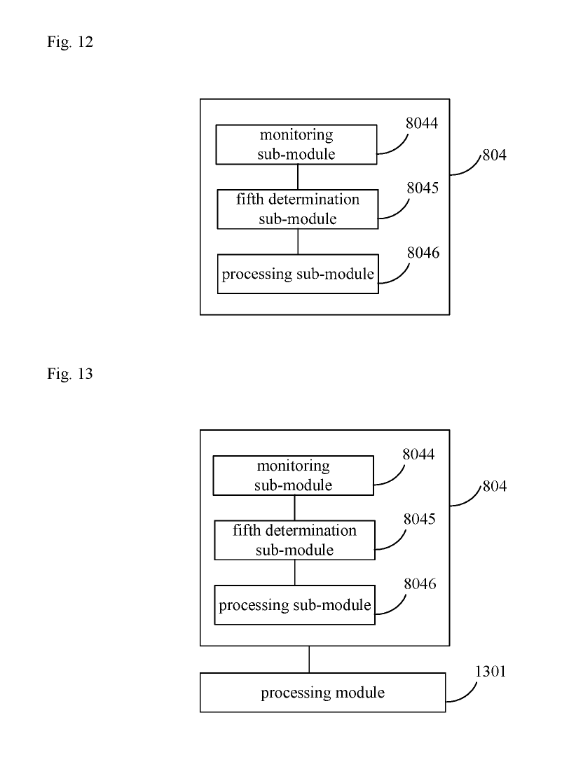

As shown in FIG. 12, in an embodiment, the second display module 804 may include: a monitoring sub-module 8044, a fifth determination sub-module 8045, and a processing sub-module 8046.

The monitoring sub-module 8044 is configured to monitor a desktop selection trajectory received by the page switching identifier when the page switching identifier is activated by the icon movement operation. The fifth determination sub-module 8045 is configured to determine a desktop the desktop page of which the relative position relationship is consistent with the movement direction selected by means of the desktop selection trajectory from the other desktop pages. The processing sub-module 8046 is configured to determine the desktop page selected by means of the desktop selection trajectory as the second desktop page, and display the second desktop page.

When moving the preset icon, the user may not expect to move the preset icon to the adjacent desktop page, and may also expect to continuously move the preset icon by N (N is a positive integer more than 2) desktop pages, so that the desktop selection trajectory received by the page switching identifier may also be monitored and the desktop selection trajectory may further be analyzed to determine the desktop page to which the user expects to move the preset icon in the desktop pages consistent with the movement direction; and therefore, the desktop page corresponding to the desktop selection trajectory is selected from the desktop pages consistent with the movement direction as the second desktop page, and the second display page is further displayed to implement movement of the preset icon from the first desktop page to the second desktop page.

In an embodiment, the first display module 803 includes: a seventh display sub-module, configured to display the page switching identifier when a distance between the preset icon and a preset reference object is smaller than a preset distance and the desktop page of which the relative position relationship is consistent with the movement direction in the other desktop pages is not null, where the preset reference object includes: the preset border or the desktop switching identifier.

Since the preset border is usually a vertical border or a transverse border, if the distance between the preset icon and the preset border to which the movement direction is/the page switching identifier is smaller than the preset distance, it is indicated that the preset icon is not positioned at a middle position of the screen and is close to the preset border/page switching identifier. On such a basis, if the desktop page of which the relative position relationship is consistent with the movement direction in the other desktop pages is not null (that is, from the first desktop page, there is other desktop pages in the movement direction), it is indicated that the preset icon may move towards the desktop page consistent with the movement direction; and therefore, the page switching identifier may be displayed to facilitate free movement of the preset icon from the first desktop page to the second desktop page through the page switching identifier.

As shown in FIG. 13, in an embodiment, the device further includes: a processing module 1301, configured to hide the page switching identifier when a preset icon hiding condition is met. The preset icon hiding condition includes at least one of the following conditions that:

the icon movement operation is not detected; or

the distance between the preset icon and the preset reference object which the movement direction is to is larger than or equal to the preset distance; or

the desktop page of which the relative position relationship is consistent with the movement direction in the other desktop pages is null.

In an embodiment, the device further includes that: a display position of the page switching identifier on the first desktop page is different from a display position of the page switching identifier on the second desktop page.

Since the second desktop page may be any desktop page other than the first desktop page in the at least two desktop pages, the display position of the page switching identifier on the first desktop page is different from the display position of the page switching identifier on the second desktop page to avoid the page switching identifier being overlapped when being displayed on different desktop pages and eliminate worries from the user about mistaken continuous desktop page switching caused by the fact that the icon is not rapidly moved away from the original position, corresponding to the page switching identifier, on the first desktop page after being moved to the second desktop page.

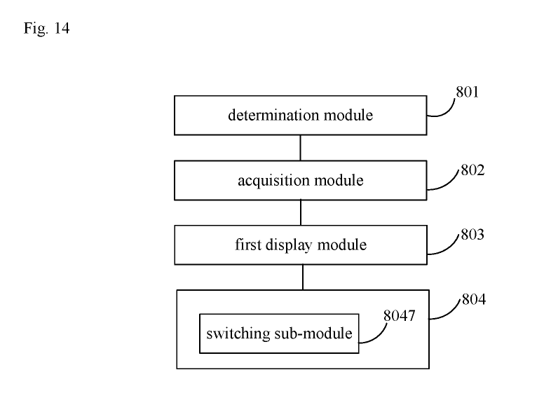

As shown in FIG. 14, in an embodiment, the second display module 804 may include: a switching sub-module 8047, configured to switch the second desktop page into a desktop page currently displayed on the touch screen to display the second desktop page when the page switching identifier is activated by the icon movement operation.

When the page switching identifier is activated by the icon movement operation, the desktop page software may be notified to switch the second desktop page into the desktop page currently displayed on the touch screen to automatically move the preset icon from the first desktop page to the second desktop page.

According to a third aspect of the present disclosure, a desktop page display device is provided, which includes: a processor; and a memory configured to store instructions executable by the processor.

The processor is configured to: determine whether an icon movement operation for a preset icon on a first desktop page is detected or not, where the first desktop page may be a desktop page currently displayed on a touch screen; acquire a movement direction of the icon movement operation when the icon movement operation is detected; display a page switching identifier corresponding to the movement direction on the first desktop page according to the movement direction; and display a second desktop page when the page switching identifier is activated by the icon movement operation, where the second desktop page may be a desktop page, other than the first desktop page, corresponding to the movement direction.

The processor may further be configured to display the second desktop page when the preset icon is moved to an area where the page switching identifier is located by the icon movement operation.

The processor may further be configured as follows.

The step that the movement direction of the icon movement operation is acquired when the icon movement operation is detected includes that:

a preset border towards which the icon movement operation is executed is determined when the icon movement operation is detected;

a direction of movement executed by the icon movement operation towards the preset border is determined as the movement direction, where the preset border may include: a first preset border or a second preset border; and

the step that the page switching identifier corresponding to the movement direction is displayed on the first desktop page includes that:

the page switching identifier of which a preset position is close to the preset border is displayed on the first desktop page.

The processor may further be configured as follows.

The step that the page switching identifier corresponding to the movement direction is displayed on the first desktop page includes that:

the page switching identifier is displayed at a position close to a right side of the screen on the first desktop page when the movement direction is from left to right; or

the page switching identifier is displayed at a position close to a left side of the screen on the first desktop page when the movement direction is from right to left; or

the page switching identifier is displayed at a position close to a lower side of the screen on the first desktop page when the movement direction is from top to bottom; or

the page switching identifier is displayed at a position close to an upper side of the screen on the first desktop page when the movement direction is from bottom to top.

In an embodiment, the step that the second desktop page is displayed when the page switching identifier is activated by the icon movement operation includes that:

a relative position relationship between other desktop pages and the first desktop page is determined when the page switching identifier is activated by the icon movement operation, where the other desktop page includes: a desktop page, other than the first desktop page, in at least two desktop pages stored in equipment where the touch screen is located; and

an adjacent desktop page of which a relative position relationship is consistent with the movement direction in the other desktop page is determined as the second desktop page, and the second desktop page is displayed.

The processor may further be configured as follows.

The step that the second desktop page is displayed when the page switching identifier is activated by the icon movement operation includes that:

a desktop selection trajectory received by the page switching identifier is monitored when the page switching identifier is activated by the icon movement operation;

a desktop page selected from the desktop page of which the relative position relationship is consistent with the movement direction in the other desktop page by means of the desktop selection trajectory is determined; and

the desktop page selected by means of the desktop selection trajectory is determined as the second desktop page, and the second desktop page is displayed.

The processor may further be configured as follows.

The step that the page switching identifier corresponding to the movement direction is displayed on the first desktop page includes that:

the page switching identifier is displayed when a distance between the preset icon and a preset reference object is smaller than a preset distance and the desktop page of which the relative position relationship is consistent with the movement direction in the other desktop page is not null, where the preset reference object includes: the preset border or the desktop switching identifier.

The processor may further be configured as follows.

The page switching identifier is hidden when a preset icon hiding condition is met, where the preset icon hiding condition includes at least one of the following conditions that:

the icon movement operation is not detected; or

the distance between the preset icon and the preset reference object is larger than or equal to the preset distance; or

the desktop page of which the relative position relationship is consistent with the movement direction in the other desktop page is null, where the preset reference object includes: the preset border or the page switching identifier.

The processor may further be configured as follows.

A display position of the page switching identifier on the first desktop page is different from a display position of the page switching identifier on the second desktop page.

The processor may further be configured as follows.

The step that the second desktop page is displayed when the page switching identifier is activated by the icon movement operation includes that:

the second desktop page is switched into a desktop page currently displayed on the touch screen to display the second desktop page when the page switching identifier is activated by the icon movement operation.

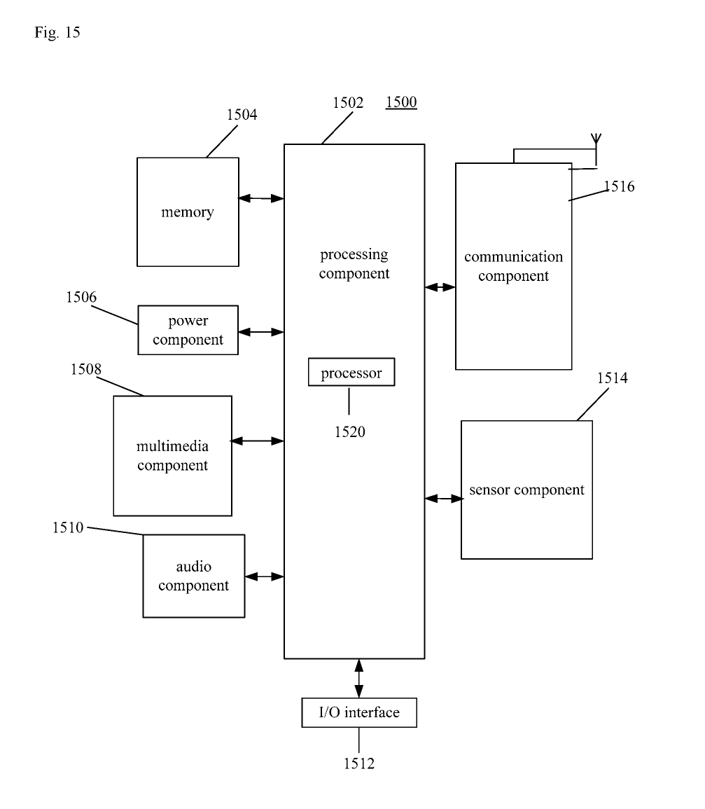

FIG. 15 is a block diagram of a desktop page display device 1500, according to an exemplary embodiment, and the device is applicable to terminal equipment. For example, the device 1500 may be a mobile phone, a computer, a digital broadcast terminal, a messaging device, a gaming console, a tablet, a medical device, exercise equipment, a personal digital assistant and the like.

Referring to FIG. 15, the device 1500 may include one or more of the following components: a processing component 1502, a memory 1504, a power component 1506, a multimedia component 1508, an audio component 1510, an Input/Output (I/O) interface 1512, a sensor component 1514, and a communication component 1516.

The processing component 1502 typically controls overall operations of the device 1500, such as the operations associated with display, telephone calls, data communications, camera operations, and recording operations. The processing component 1502 may include one or more processors 1520 to execute instructions to perform all or part of the steps in the abovementioned method. Moreover, the processing component 1502 may include one or more modules which facilitate interaction between the processing component 1502 and the other components. For instance, the processing component 1502 may include a multimedia module to facilitate interaction between the multimedia component 1508 and the processing component 1502.

The memory 1504 is configured to store various types of data to support the operation of the device 1500. Examples of such data include instructions for any storage objects or methods operated on the device 1500, contact data, phonebook data, messages, pictures, video, etc. The memory 1504 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1506 provides power for various components of the device 1500. The power component 1506 may include a power management system, one or more power supplies, and other components associated with the generation, management and distribution of power for the device 1500.

The multimedia component 1508 includes a screen providing an output interface between the device 1500 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 1508 includes a front camera and/or a rear camera. The front camera and/or the rear camera may receive external multimedia data when the device 1500 is in an operation mode, such as a photographing mode or a video mode. Each of the front camera and the rear camera may be a fixed optical lens system or have focusing and optical zooming capabilities.

The audio component 1510 is configured to output and/or input an audio signal. For example, the audio component 1510 includes a Microphone (MIC), and the MIC is configured to receive an external audio signal when the device 1500 is in the operation mode, such as a call mode, a recording mode and a voice recognition mode. The received audio signal may be further stored in the memory 1504 or sent through the communication component 1516. In some embodiments, the audio component 1510 further includes a speaker configured to output the audio signal.

The I/O interface 1512 provides an interface between the processing component 1502 and a peripheral interface module, and the peripheral interface module may be a keyboard, a click wheel, a button and the like. The button may include, but not limited to: a home button, a volume button, a starting button and a locking button.

The sensor component 1514 includes one or more sensors configured to provide status assessment in various aspects for the device 1500. For instance, the sensor component 1514 may detect an on/off status of the device 1500 and relative positioning of components, such as a display and small keyboard of the device 1500, and the sensor component 1514 may further detect a change in a position of the device 1500 or a component of the device 1500, presence or absence of contact between the user and the device 1500, orientation or acceleration/deceleration of the device 1500 and a change in temperature of the device 1500. The sensor component 1514 may include a proximity sensor configured to detect presence of an object nearby without any physical contact. The sensor component 1514 may also include a light sensor, such as a Complementary Metal Oxide Semiconductor (CMOS) or Charge Coupled Device (CCD) image sensor, configured for use in an imaging application. In some embodiments, the sensor component 1514 may also include an acceleration sensor, a gyroscope sensor, a magnetic sensor, a pressure sensor or a temperature sensor.

The communication component 1516 is configured to facilitate wired or wireless communication between the device 1500 and another device. The device 1500 may access a communication-standard-based wireless network, such as a Wireless Fidelity (Wi-Fi) network, a 2nd-Generation (2G) or 3rd-Generation (3G) network or a combination thereof. In an exemplary embodiment, the communication component 1516 receives a broadcast signal or broadcast associated information from an external broadcast management system through a broadcast channel. In an exemplary embodiment, the communication component 1516 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BlueTooth (BT) technology and another technology.

In an exemplary embodiment, the device 1500 may be implemented by one or more circuitries, which include Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components. The device 1500 may use the circuitries in combination with the other hardware or software components for performing the above described methods. Each module, sub-module, unit, or sub-unit in the disclosure may be implemented at least partially using the one or more circuitries.

In an exemplary embodiment, there is also provided a non-transitory computer-readable storage medium including an instruction, such as the memory 1504 including an instruction, and the instruction may be executed by the processor 1520 of the device 1500 to implement the abovementioned method. For example, the non-transitory computer-readable storage medium may be a ROM, a Radom Access Memory (RAM), a Compact Disc Read-Only Memory (CD-ROM), a magnetic tape, a floppy disc, an optical data storage device and the like.

A non-transitory computer-readable storage medium has instructions stored therein, when being executed by the processor of the device 1500, to enable the device 1500 to execute a desktop page display method, the method including that:

whether an icon movement operation for a preset icon on a first desktop page is detected or not is determined, where the first desktop page may be a desktop page currently displayed on a touch screen;

a movement direction of the icon movement operation is acquired when the icon movement operation is detected;

a page switching identifier corresponding to the movement direction is displayed on the first desktop page according to the movement direction; and

a second desktop page is displayed when the page switching identifier is activated by the icon movement operation, where the second desktop page may be a desktop page, other than the first desktop page, corresponding to the movement direction.

In an embodiment, the step that the second desktop page is displayed when the page switching identifier is activated by the icon movement operation includes that:

the second desktop page is displayed when the preset icon is moved to an area where the page switching identifier is located by the icon movement operation.

In an embodiment, the step that the movement direction of the icon movement operation is acquired when the icon movement operation is detected includes that:

a preset border towards which the icon movement operation is executed is determined when the icon movement operation is detected;

a direction of movement executed by the icon movement operation towards the preset border is determined as the movement direction, where the preset border includes: a first preset border or a second preset border; and

the step that the page switching identifier corresponding to the movement direction is displayed on the first desktop page includes that:

the page switching identifier of which a preset position is close to the preset border is displayed on the first desktop page.

In an embodiment, the step that the page switching identifier corresponding to the movement direction is displayed on the first desktop page includes that:

the page switching identifier is displayed at a position close to a right side of the screen on the first desktop page when the movement direction is from left to right; or

the page switching identifier is displayed at a position close to a left side of the screen on the first desktop page when the movement direction is from right to left; or

the page switching identifier is displayed at a position close to a lower side of the screen on the first desktop page when the movement direction is from top to bottom; or

the page switching identifier is displayed at a position close to an upper side of the screen on the first desktop page when the movement direction is from bottom to top.

In an embodiment, the step that the second desktop page is displayed when the page switching identifier is activated by the icon movement operation includes that:

a relative position relationship between other desktop pages and the first desktop page is determined when the page switching identifier is activated by the icon movement operation, where the other desktop page includes: a desktop page, except the first desktop page, in at least two desktop pages stored in equipment where the touch screen is located; and

an adjacent desktop page of which a relative position relationship is consistent with the movement direction in the other desktop page is determined as the second desktop page, and the second desktop page is displayed.

In an embodiment, the step that the second desktop page is displayed when the page switching identifier is activated by the icon movement operation includes that:

a desktop selection trajectory received by the page switching identifier is monitored when the page switching identifier is activated by the icon movement operation;

a desktop the desktop page of which the relative position relationship is consistent with the movement direction selected by means of the desktop selection trajectory from the other desktop pages is determined; and

the desktop page selected by means of the desktop selection trajectory is determined as the second desktop page, and the second desktop page is displayed.

In an embodiment, the step that the page switching identifier corresponding to the movement direction is displayed on the first desktop page includes that:

the page switching identifier is displayed when a distance between the preset icon and a preset reference object is smaller than a preset distance and the desktop page of which the relative position relationship is consistent with the movement direction in the other desktop pages is not null, where the preset reference object includes: the preset border or the desktop switching identifier.

In an embodiment, the method further includes that:

the page switching identifier is hidden when a preset icon hiding condition is met, where the preset icon hiding condition includes at least one of the following conditions that:

the icon movement operation is not detected; or

the distance between the preset icon and the preset reference object is larger than or equal to the preset distance; or

the desktop page of which the relative position relationship is consistent with the movement direction in the other desktop pages is null, where the preset reference object includes: the preset border or the page switching identifier.

In an embodiment, the method further includes that:

a display position of the page switching identifier on the first desktop page is different from a display position of the page switching identifier on the second desktop page.

In an embodiment, the step that the second desktop page is displayed when the page switching identifier is activated by the icon movement operation includes that:

the second desktop page is switched into a desktop page currently displayed on the touch screen to display the second desktop page when the page switching identifier is activated by the icon movement operation.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method, comprising:
determining, by a device comprising a touch screen controlled by at least one processor, whether an icon movement operation is detected for a preset icon on a first page currently displayed on the touch screen;
acquiring a movement direction of the icon movement operation when the icon movement operation is detected on the first page;
displaying a page switching identifier corresponding to the movement direction on the first page according to the movement direction; and
displaying a second page on the touch screen when the page switching identifier is activated by the icon movement operation, wherein the second page is different from the first page, corresponding to the movement direction.

2. The method according to claim 1, wherein displaying the second page on the touch screen when the page switching identifier is activated by the icon movement operation comprises:
displaying the second page when the preset icon is moved to an area where the page switching identifier is located by the icon movement operation.

3. The method according to claim 1, wherein acquiring the movement direction of the icon movement operation when the icon movement operation is detected comprises:
determining a preset border towards which the icon movement operation is executed when the icon movement operation is detected;
determining a direction of movement executed by the icon movement operation towards the preset border as the movement direction, wherein the preset border comprises one of: a first preset border and a second preset border; and
wherein displaying the page switching identifier corresponding to the movement direction on the first page comprises:
displaying the page switching identifier with a preset position that is close to the preset border on the first page.

4. The method according to claim 1, wherein displaying the page switching identifier corresponding to the movement direction on the first page comprises:
displaying the page switching identifier at a position close to a right side of the screen on the first page when the movement direction is from left to right; or
displaying the page switching identifier at a position close to a left side of the screen on the first page when the movement direction is from right to left; or
displaying the page switching identifier at a position close to a lower side of the screen on the first page when the movement direction is from top to bottom; or
displaying the page switching identifier at a position close to an upper side of the screen on the first page when the movement direction is from bottom to top.

5. The method according to claim 1, wherein displaying the second page when the page switching identifier is activated by the icon movement operation comprises:
determining a relative position relationship between other pages and the first page when the page switching identifier is activated by the icon movement operation, wherein the other pages comprises a page, other than the first page, in at least two pages stored in equipment where the touch screen is located; and
determining an adjacent page of which a relative position relationship is consistent with the movement direction in the other pages as the second page, and displaying the second page.

6. The method according to claim 5, wherein displaying the second page when the page switching identifier is activated by the icon movement operation comprises:
monitoring a desktop selection trajectory received by the page switching identifier when the page switching identifier is activated by the icon movement operation;
determining a target page whose relative position relationship is consistent with the movement direction, selected by means of the desktop selection trajectory from the other pages; and
determining the target page selected by means of the desktop selection trajectory as the second page, and displaying the second page.

7. The method according to claim 6, wherein displaying the page switching identifier corresponding to the movement direction on the first page comprises:
displaying the page switching identifier when a distance between the preset icon and a preset reference object is smaller than a preset distance and the page of which the relative position relationship is consistent with the movement direction in the other pages is not null, wherein the preset reference object comprises the preset border or the desktop switching identifier.

8. The method according to claim 6, further comprising:
hiding the page switching identifier when a preset icon hiding condition is met, wherein the preset icon hiding condition comprises at least one of the following conditions that:
the icon movement operation is not detected;
the distance between the preset icon and the preset reference object is larger than or equal to the preset distance; and
the page of which the relative position relationship is consistent with the movement direction in the other pages is null, wherein the preset reference object comprises the preset border or the page switching identifier.

9. The method according to claim 2, further comprising:
determining that a display position of the page switching identifier on the first page is different from a display position of the page switching identifier on the second page.

10. The method according to claim 1, wherein displaying the second page when the page switching identifier is activated by the icon movement operation comprises:
switching the second page into a page currently displayed on the touch screen to display the second page when the page switching identifier is activated by the icon movement operation.

11. A device, comprising:
a processor and a touch screen electronically connected to the processor; and
a memory configured to store instructions executable by the processor,
wherein the processor is configured to:
determine whether an icon movement operation for a preset icon is detected on a first page currently displayed on the touch screen;
acquire a movement direction of the icon movement operation when the icon movement operation is detected on the first page;
instruct the touch screen to display a page switching identifier corresponding to the movement direction on the first page according to the movement direction; and
instruct the touch screen to display a second page when the page switching identifier is activated by the icon movement operation corresponding to the movement direction, wherein the second page is different from the first page,.

12. The device according to claim 11, wherein the processor is further configured to:
instruct the touch screen to display the second page when the preset icon is moved to an area where the page switching identifier is located by the icon movement operation, wherein a display position of the page switching identifier on the first page is different from a display position of the page switching identifier on the second page.

13. The device according to claim 11, wherein the processor is further configured to:
determine a preset border towards which the icon movement operation is executed when the icon movement operation is detected;
determine a direction of movement executed by the icon movement operation towards the preset border as the movement direction, wherein the preset border comprises a first preset border or a second preset border; and
instruct the touch screen to display the page switching identifier with a preset position that is close to the preset border on the first page.

14. The device according to claim 11, wherein the processor is further configured to instruct the touch screen to:
display the page switching identifier at a position close to a right side of the screen on the first page when the movement direction is from left to right; or
display the page switching identifier at a position close to a left side of the screen on the first page when the movement direction is from right to left; or
display the page switching identifier at a position close to a lower side of the screen on the first page when the movement direction is from top to bottom; or
display the page switching identifier at a position close to an upper side of the screen on the first page when the movement direction is from bottom to top.

15. The device according to claim 13, wherein the processor is further configured to:
determine a relative position relationship between other pages and the first page when the page switching identifier is activated by the icon movement operation, wherein the other pages comprises a page, other than the first page, in at least two pages stored in equipment where the touch screen is located; and
determine an adjacent page of which a relative position relationship is consistent with the movement direction in the other pages as the second page, and display the second page.

16. The device according to claim 15, wherein the processor is further configured to:
monitor a desktop selection trajectory received by the page switching identifier when the page switching identifier is activated by the icon movement operation;
determine a target page whose relative position relationship is consistent with the movement direction selected by means of the desktop selection trajectory from the other pages; and
determine the target page selected by means of the desktop selection trajectory as the second page, and display the second page.

17. The device according to claim 15, wherein the processor is further configured to:
instruct the touch screen to display the page switching identifier when a distance between the preset icon and a preset reference object is smaller than a preset distance and the page of which the relative position relationship is consistent with the movement direction in the other pages is not null, wherein the preset reference object comprises: the preset border or the desktop switching identifier.

18. The device according to claim 15, wherein the processor is further configured to:
instruct the touch screen to hide the page switching identifier when a preset icon hiding condition is met, wherein the preset icon hiding condition comprises at least one of the following conditions that:
the icon movement operation is not detected;
the distance between the preset icon and the preset reference object is larger than or equal to the preset distance; and
the page of which the relative position relationship is consistent with the movement direction in the other pages is null, wherein the preset reference object comprises: the preset border or the page switching identifier.

19. The device according to claim 11, wherein the processor is further configured to:
switch the second page into a page currently displayed on the touch screen to display the second page when the page switching identifier is activated by the icon movement operation.

20. A non-transitory computer-readable storage medium having stored therein instructions that, when executed by a processor of a mobile terminal comprising a touch screen, causes the mobile terminal to perform acts comprising:
determining whether an icon movement operation for a preset icon on a first page is detected or not, wherein the first page is a page currently displayed on the touch screen;
acquiring a movement direction of the icon movement operation when the icon movement operation is detected;
displaying a page switching identifier corresponding to the movement direction on the first page according to the movement direction; and
displaying a second page when the page switching identifier is activated by the icon movement operation corresponding to the movement direction, wherein the second page is different from the first page.
